(19) United States
(12) Patent Application Publication
(10) Pub. No.: US 2006/0195844 A1
(43) Pub. Date: Aug. 31, 2006

(54) Task execution mechanism with automated condition checking and compensation

(75) Inventor: Mihai R. Jalobeanu, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/065,885

(22) Filed: Feb. 25, 2005

(51) Int. Cl. G06F 9/46

(52) U.S. Cl. 718/102

(57) ABSTRACT

A method of executing a task in a manner that verifies that performance of the task will likely be successful. This may be accomplished using a task object that specifies one or more preconditions that must be satisfied in order for the task to be successful. The preconditions are verified using condition objects. If the preconditions are not satisfied, the task fails before its execution even began. On the other hand, if the preconditions are satisfied, the task is executed. This may be accomplished by, for example, calling an execution method of the task object. If the execution fails, the task may be undone by, for example, calling a compensation method of the task object. After execution, one or more postconditions may be verified in a similar manner. If the postconditions are not satisfied, then the compensation method may be called in that circumstance as well.

### BACKGROUND OF THE INVENTION

1. The Field of the Invention

The present invention relates to computing technology; and more specifically, to mechanisms for executing a task with automated condition checking to avoid unnecessarily attempting to execute the task if the task cannot be completed, and with automated compensation to undo the task if the task is attempted but cannot be completed.

2. Background and Related Art

Computing technology has transformed the way we work and play. Computing systems now take a wide variety of forms including desktop computers, laptop computers, tablet PCs, Personal Digital Assistants (PDAs), household devices and the like. In its most basic form, a computing system includes system memory and one or more processors. Software in the system memory may be executed by the processor to direct the other hardware of the computing system to perform desired functions.

Many software applications must have reliable access to accurate data in order to function properly. Applications that use data stored in a non-transactional data store can suffer from inherent reliability problems because incomplete changes made to the data in the data store may result in loss in data, or relational integrity of the data. Such incomplete changes may have been made when a sequence of actions ends unexpectedly prior to completion. In a transactional data store, the sequence of actions may simply be rolled back to its initial state as though the sequence of actions never began, thereby ensuring data integrity. A non-transactional data store does not provide this option.

A common solution to this problem is a Compensating Resource Manager (CRM), which controls and monitors the sequence of components that perform the actions. The action execution is usually done in two phases. In the first phase, the CRM instructs all participating components to acquire their resources. In the second phase, the CRM instructs the components to commit the changes. If the components were to fail, the CRM issues a sequence of compensating actions to undo the incomplete changes.

The CRM is able to recover the initial data as it existed prior to the sequence of actions. However, the CRM may waste processing resources since it does not detect whether or not the sequence of actions has a logical flaw that would necessarily cause the sequence of actions to fail. Instead, the CRM causes the sequence of actions to commence, regardless of the futility of doing so, until the execution actually fails due to the logical flaw. For example, a sequence that consists of Delete(x), followed by Copy(x) will necessarily fail, because the parameter “x” will not exist at the time the method Copy(x) is initiated. Therefore, Copy(x) (and the action sequence) must necessarily fail.

Accordingly, what would be advantageous are mechanisms that permit logical flaws in a task to be detected without actually exercising futility in commencing the task. It would further be desirable if such a mechanism provided a way to roll back any changes should the task fail regardless of the precondition checking.

### BRIEF SUMMARY OF THE INVENTION

The foregoing problems with the prior state of the art are overcome by the principles of the present invention, which are directed towards a method of executing a task in a manner that verifies that performance of the task will not likely result in failure prior to executing the task.

This may be accomplished using a task object that specifies one or more preconditions that must be satisfied in order for the task to be successful. The mechanism permits the preconditions to be verified by providing condition objects. A verification method of the condition object may be called, which returns, for example an actual value(s) corresponding to particular parameter(s). The verification of the condition may be performed by, for example, comparing the actual value returned with an expected value. If the preconditions are not satisfied, the task will be deemed to fail before its execution even began. On the other hand, if the preconditions are satisfied, the task may then be executed. This may be accomplished by, for example, calling an execution method of the task object. If the execution fails, the task may be undone by, for example, calling a compensation method of the task object. After execution, one or more postconditions may be verified in a similar manner. If the postconditions are not satisfied, then the compensation method may at be called in that circumstance as well.

Accordingly, it is more likely that if execution of the task is initiated that the execution will be successful. In one embodiment, the task is performed on a non-transactional data store. Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable computing system that may implement features of the present invention;

FIG. 2 schematically illustrates a flowchart of a computerized method for executing a single task only if preconditions for the task are met, and for compensating for the task if postconditions for the task are not met in accordance with the principles of the present invention;

FIG. 3 schematically illustrates a task object including a preconditions data structure, a postconditions data structure, an initialize method, an execute method, and a compensate method in accordance with the principles of the present invention; and

FIG. 4 schematically illustrates condition objects that each verify a condition using a verification method by providing an actual value associated with a parameter.

### DETAILED DESCRIPTION OF THE PREFERRED EMBODIMENTS

The principles of the present invention relate to a method of executing a task in a manner that verifies that performance of the task will not likely result in failure. This may be accomplished using a task object that specifies one or more preconditions that must be satisfied in order for the task to be successful. The mechanism permits the preconditions to be verified by providing condition objects. If the preconditions are not satisfied, the task will be deemed to fail before its execution even began. On the other hand, if the preconditions are satisfied, the task may then be executed. This may be accomplished by, for example, calling an execution method of the task object. If the execution fails, the task may be undone by, for example, calling a compensation method of the task object. After execution, one or more postconditions may be verified in a similar manner. If the postconditions are not satisfied, then the compensation method may be called in that circumstance as well.

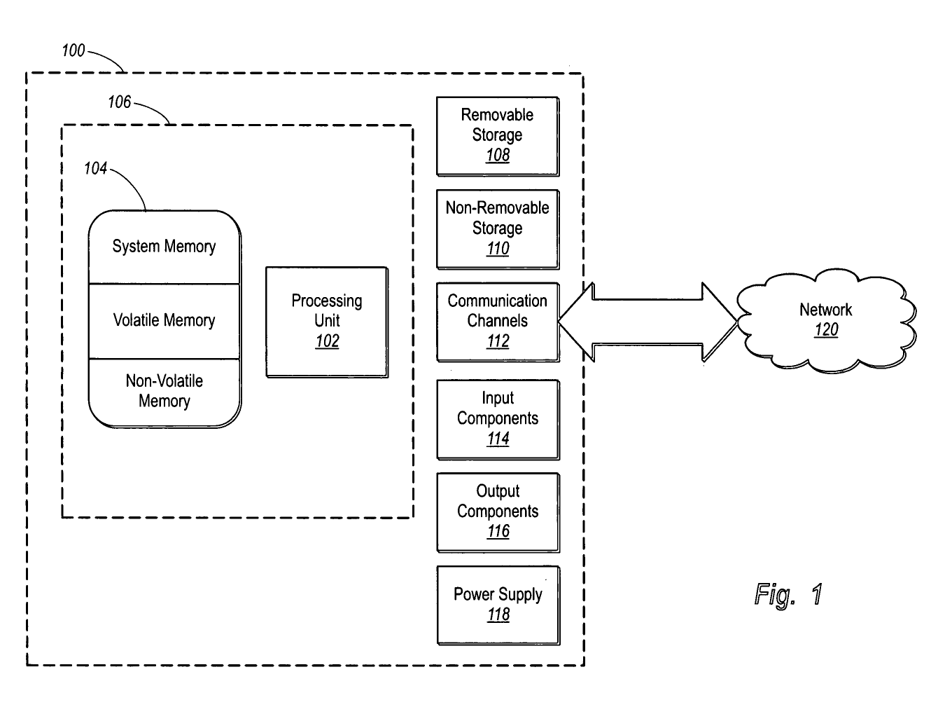

Prior to describing the details of the principles of the present invention, a suitable computing architecture that may be used to implement the principles of the present invention will be described with respect to FIG. 1. In the description that follows, embodiments of the invention are described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the principles of the invention are being described in the foregoing context, it is not meant to be limiting as those of skill in the art will appreciate that several of the acts and operations described hereinafter may also be implemented in hardware.

Turning to the drawings, wherein like reference numerals refer to like elements, the principles of the present invention are illustrated as being implemented in a suitable computing environment. The following description is based on illustrated embodiments of the invention and should not be taken as limiting the invention with regard to alternative embodiments that are not explicitly described herein.

FIG. 1 shows a schematic diagram of an example computer architecture usable for these devices. For descriptive purposes, the architecture portrayed is only one example of a suitable environment and is not intended to suggest any limitation as to the scope of use or functionality of the invention. Neither should the computing systems be interpreted as having any dependency or requirement relating to any one or combination of components illustrated in FIG. 1.

The principles of the present invention are operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing system 100 typically includes at least one processing unit 102 and memory 104. The memory 104 may be volatile (such as RAM), non-volatile (such as ROM, flash memory, etc.), or some combination of the two. This most basic configuration is illustrated in FIG. 1 by the dashed line 106. In this description and in the claims, a “computing system” is defined as any hardware component or combination of hardware components capable of executing software, firmware or microcode to perform a function. The computing system may even be distributed to accomplish a distributed function.

The storage media devices may have additional features and functionality. For example, they may include additional storage (removable and non-removable) including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing system.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in software and hardware or hardware are also possible and contemplated. In this description, a “computing entity” may be any computing system as previously defined herein, or any module or combination of modulates running on a computing system.

Computing system 100 may also contain communication channels 112 that allow the host to communicate with other systems and devices over, for example, network 120. Communication channels 112 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computing system 100 may also have input components 114 such as a keyboard, mouse, pen, a voice-input component, a touch-input device, and so forth. Output components 116 include screen displays, speakers, printer, etc., and rendering modules (often called “adapters”) for driving them. The computing system 100 has a power supply 118. All these components are well known in the art and need not be discussed at length here.

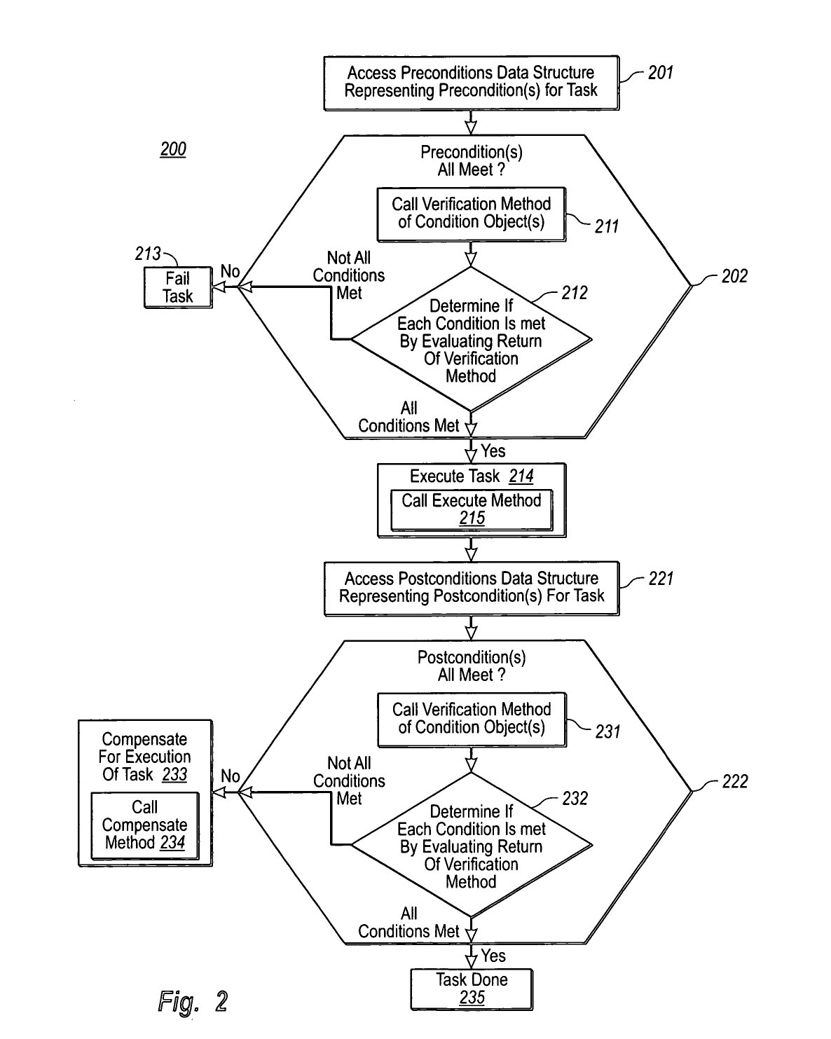

FIG. 2 illustrates a flowchart of a method 200 for a computing system to execute a task in accordance with the principles of the present invention. The computing system may be similar to the computing system 100 described above with respect to FIG. 1, although that need not be the case. The task may be performed by any suitably configured computing system that is capable of executing computer-executable instructions using one or more processors. The computing system may even be distributed amongst multiple computing systems.

The method 200 reduces the chance that the task will be executed in an invalid state by confirming that the task is internally consistent and that the data on which the task is supposed to operate is valid. The task includes one or more preconditions that must be true prior to the execution of the task in order for the task to be internally consistent. The task also may also include one or more postconditions that should be true after the task is executed in order to the task to be internally consistent. An example of a precondition or a postcondition may be represented with human-readable text as “a user with the specified email address exists in the system”.

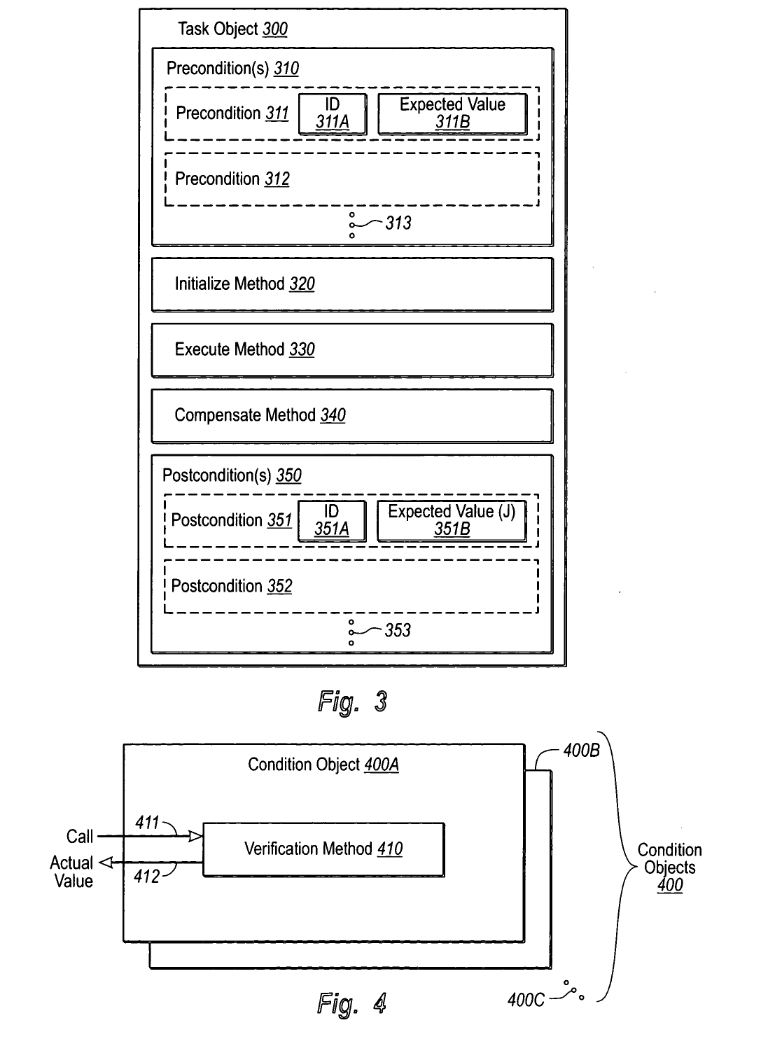

Referring to FIG. 2, the computing system accesses a preconditions data structure that represents one or more preconditions for the task (act 201). In one embodiment, the preconditions data structure is present within a task object corresponding to the task to be performed. For instance, FIG. 3 schematically illustrates a task object 300 that includes a preconditions data structure 310. In the case of FIG. 3, the preconditions data structure 310 is shown as including two preconditions 311 and 312, among potentially others as represented by the vertical ellipses 313. However, the preconditions data structure of act 201 may include any number of preconditions.

As represented in precondition 311, although not required, the precondition may include an identifier field 311A identifying the parameter or general condition corresponding to a condition object that will be explained further below. The precondition 311 is illustrated as including the expected value(s) field 311B that expresses expected values for one or more parameters associated with the condition. The expected value may be a single value, multiple values, a range of values, multiple ranges of values, or combinations thereof.

Returning to FIG. 2, after accessing the preconditions data structure (act 201), the computing system determines whether or not all of the one or more preconditions for the task are satisfied (decision block 202). This may be accomplished using condition objects such as those illustrated with respect to FIG. 4. As represented in FIG. 4, each condition object may include a verification method that may be called to return an actual value corresponding to one or more particular parameters. For example, FIG. 4 shows that there may be a variety of condition objects 400 for a variety of conditions including, for example, condition object 400A, condition object 400B, amongst potentially many others as represented by the ellipses 400C. The condition object 400A includes a verification method 410 that may be called (act 211) as represented by arrow 411 to determine the actual value associated with a parameter. The actual value 412 for the parameter is returned to the caller in response to the call. The computing system may verify whether a condition is true by evaluating the return of the call. For example, after calling 411 the verification method 410 of the condition object 400, the verification method returns 412 an actual value associated with zero or more parameters. The computing system may then determine whether or not the condition is met by determining whether or not the actual value conforms with the expected value(s) for the parameter(s). This process may be repeated for each precondition.

Returning to FIG. 2, if the precondition(s) are not determined to all be satisfied (NO in decision block 212), the task fails (act 213). For example, perhaps the actual value returned by a condition object corresponding to one of the preconditions does not correspond with an expected value for that precondition. This failing of the task occurs without the associated task being executed (see act 214). This failing is appropriate since the preconditions are not met, and thus there is some logical inconsistency in the task or in the data on which the task is supposed to act. Therefore, processing, memory, and other resources are not wasted by executing a task that will ultimately fail.

On the other hand, if the precondition(s) are determined to all be satisfied (YES in decision block 212), the task is executed (act 214). For example, perhaps the actual values returned by condition objects corresponding to all of the preconditions all correspond with the respective expected values for those preconditions. The execution of the task may be accomplished by, for example, calling an execution method of a task object corresponding to the task (act 215). For example, task object 300 is illustrated as including execution method 330. The execution method 330 may include some or all of the computer-executable instructions needed to accomplish the task, although the execution method 330 may call into other objects in order to accomplish all parts of the task. The task object 300 may also include an initialization method 320 to initialize the task object to a particular state needed or desired prior to execution of the task, although the initialization may instead be part of the execution method.

The execution of the task is much more likely to be successful using this method assuming that the preconditions for successful execution of the task are accurately represented. However, there is still no guaranty that the execution of the task will result in an accurate or desirable state. Accordingly, the method 200 may optionally include various acts for verifying that postconditions for the task are met, and taking appropriate compensatory action if any of the postconditions are not met.

For instance, the computing system may access a postconditions data structure that represents one or more postconditions for the task (act 221). The postconditions data structure may also be within the associated task object for the task. For instance, task object 300 includes postconditions data structure 350. The postconditions data structure may be similar to the preconditions data structure. For instance, postconditions data structure 350 is illustrated as including two postconditions 351 and 352 amongst others as represented by the vertical ellipses 353. The postcondition 351 is shown as including an identifier field 351A that may identify (directly or indirectly) the condition, as well as an expected value field 351B. The act of accessing the postconditions (act 221) is illustrated as being directly after the execution of the task (act 214). However, the postconditions may be accessed at any point before determining whether or not all of the post condition(s) are satisfied (act 222).

After the execution of the task, the computing system determines whether or not all of the one or more postconditions are satisfied (act 222). This may be accomplished by, for example, calling a verification method of a condition object corresponding to each of the postcondition(s) for the task (act 231), and determining whether the postcondition is met by evaluating a return of the call of the verification method of the postcondition object (decision block 232). Once again, an actual value returned by the condition object may be compared with an expected value represented in the postconditions data structure.

If the one or more postconditions are not determined to all be satisfied (NO in decision block 232), the computing system compensates for the task execution (act 233) by, for example, calling a compensate method of the task object (act 234). For example task object 300 is illustrated as including a compensate method 340. A condition object may be used for both preconditions and postconditions. Accordingly, a condition object of a single class may, but need not, correspond to both a precondition for a task and a postcondition for the task.

The following is a source code example of a condition object corresponding to condition object 400 of FIG. 4 with line numbering added for clarity.

1. public class UserExistsCondition:Condition

2. {public string EmailAddress;

3. public bool Verify( ) { }}

Line 1 is a declaration defining a class of the type “Condition” called “UserExistsCondition”. The class verifies that a user corresponding to an e-mail address exists in a database. Line 2 represents the condition argument of “EmailAddress”, which is a string representing the e-mail address of the user that is to be verified as existing in the database. Line 3 is a declaration of the Verify method, which may be called with the “EmailAddress” as the input parameter. The condition would then return a Boolean representing whether or not the user is present.

The following is an example of a task object that follows the general structure of the task object 300 of FIG. 3 with line numbers added for clarity.

1. public class DeleteUser: Task

2. {public string EmailAddress {get; set;}

3. public void Initialize( ){ . . . }

4. public void Execute( ) { . . . }

5. public void Undo( ) { . . . }

6. [Precondition(ExpectedResult=true)]

7. [Postcondition(ExpectedResult=false)]

8. private UserExistsCondition UserExists {get {return new UserExistsCondition(EmailAddress);}}}

The task deletes a user with a specified e-mail address. Line 1 declares the class of type “Task” and titled “DeleteUser”. Line 2 defines the parameters of the task, which is the “EmailAddress” parameter that has associated “get” and “set” methods. Line 3 declares the initialization method. Line 4 declares the execution method. Line 5 declares the compensation method (called “Undo”). Line 6 is the preconditions data structure that identifies the expected result for a particular precondition. Line 7 is a postconditions data structure that identifies the expected result for a particular postcondition. Line 8 identifies the particular condition, which represents both the precondition and the postcondition.

Accordingly, the principles of the present invention provide an organized model for representing preconditions and postconditions for a task, checking the preconditions prior to execution of the task to preserve processing resources should the task be logically inconsistent, compensating for the task if need be, and verifying that the postconditions for the task are met.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. In a computing system that includes one or more processors and a computer-readable media having thereon computer-executable instructions, a method for the computing system to execute a task by executing the computer-executable instructions by the one or more processors, the method comprising the following:
an act of accessing a preconditions data structure that represents one or more preconditions for the task;
an act of determining whether or not all of the one or more preconditions for the task are satisfied comprising:
an act of calling a verification method of a condition object corresponding to at least one of the one or more preconditions for the task; and
an act of determining whether the condition is met by evaluating a return of the call of the verification method of the condition object;
if the one or more preconditions are not determined to all be satisfied, an act of failing execution of the task; and
if the one or more preconditions are determined to all be satisfied, an act of executing the task.

2. A method in accordance with claim 1, wherein the preconditions data structure is in a task object corresponding to the task.

3. A method in accordance with claim 2, wherein preconditions data structure represents an expected result of a particular question, and the return of the call of the verification method of the condition object includes an actual result of the particular question, wherein the act of determining whether the precondition is met comprises the following:
if the actual result does not correspond to the expected result, an act of determining that the precondition is not met; and
if the actual result does correspond to the expected result, an act of determining that the precondition is met.

4. A method in accordance with claim 3, wherein the act of executing the task comprising an act of calling a method of the task object.

5. A method in accordance with claim 2, wherein the act of executing the task comprising an act of calling a method of the task object.

6. A method in accordance with claim 1, wherein the one or more conditions are determined to all be satisfied, the method further comprising:
an act of accessing a postconditions data structure that represents one or more postconditions for the task;
after the act of executing the task, an act of determining whether or not all of the one or more postconditions are satisfied comprising:
an act of calling a verification method of a condition object corresponding to at least one of the one or more postconditions for the task; and
an act of determining whether the postcondition is met by evaluating a return of the call of the verification method of the condition object; and
if the one or more postconditions are not determined to all be satisfied, an act of compensating for the act of executing the task.

7. A method in accordance with claim 6, wherein the postconditions data structure is in a task object corresponding to the task.

8. A method in accordance with claim 7, wherein postconditions data structure represents an expected result of a particular question, and the return of the call of the verification method of the condition object includes an actual result of the particular question, wherein the act of determining whether the postcondition is met comprises the following:
if the actual result does not correspond to the expected result, an act of determining that the postcondition is not met; and
if the actual result does correspond to the expected result, an act of determining that the postcondition is met.

9. A method in accordance with claim 8, wherein the act of compensating for the act of executing the task comprises an act of calling a method of the task object.

10. A method in accordance with claim 7, wherein the act of compensating for the act of executing the task comprises an act of calling a method of the task object.

11. In a computing system that includes one or more processors and a computer-readable media having thereon computer-executable instructions, a method for the computing system to execute a task by executing the computer-executable instructions by the one or more processors, the method comprising the following:
an act of accessing a task object that includes a preconditions data structure that represents one or more preconditions for the task;
an act of determining whether or not all of the one or more preconditions for the task are satisfied comprising:
an act of calling a verification method of a condition object corresponding to at least one of the one or more preconditions for the task; and
an act of determining whether the precondition is met by evaluating a return of the call of the verification method of the condition object;
if the one or more preconditions are not determined to all be satisfied, an act of failing execution of the task; and
if the one or more preconditions are determined to all be satisfied, an act of executing the task by calling an execution method of the task object.

12. A method in accordance with claim 11, wherein preconditions data structure represents an expected result of a particular question, and the return of the call of the verification method of the condition object includes an actual result of the particular question, wherein the act of determining whether the precondition is met comprises the following:
if the actual result does not correspond to the expected result, an act of determining that the precondition is not met; and
if the actual result does correspond to the expected result, an act of determining that the precondition is met.

13. A method in accordance with claim 11, wherein the one or more conditions are determined to all be satisfied, and the task object further includes a postconditions data structure that represents one or more postconditions for the task, the method further comprising:
after the act of executing the task, an act of determining whether or not all of the one or more postconditions are satisfied comprising:
an act of calling a verification method of a condition object corresponding to at least one of the one or more postconditions for the task; and
an act of determining whether the postcondition is met by evaluating a return of the call of the verification method of the condition object;
if the one or more postconditions are not determined to all be satisfied, an act of compensating for the act of executing the task by calling a compensation method of the task object.

14. A method in accordance with claim 13, wherein postconditions data structure represents an expected result of a question, and the return of the call of the verification method of the condition object includes an actual result of the particular question, wherein the act of determining whether the postcondition is met comprises the following:
if the actual result does not correspond to the expected result, an act of determining that the postcondition is not met; and
if the actual result does correspond to the expected result, an act of determining that the postcondition is met.

15. A method in accordance with claim 13, wherein the postcondition object and the precondition object are the same condition object.

16. A method in accordance with claim 13, wherein the postcondition object and the precondition object are different condition objects.

17. One or more computer-readable media having thereon task object data structure, the task object data structure comprising the following:
a preconditions data structure representing one or more preconditions for a task;
an execution method that includes one or more computer-readable media that, when executed by one or more processors, performs the task;
a compensation method that includes one or more computer-executable instructions that, when executed by the one or more processors, undoes the effects of the execution method; and
a postconditions data structure representing one or more postconditions for the task.

18. The one or more computer-readable media in accordance with claim 17, wherein for at least one of the preconditions, there is a parameter and an expected result for the parameter.

19. The one or more computer-readable media in accordance with claim 18, wherein for at least one of the postconditions, there is a parameter and an expected result for the parameter.

20. The one or more computer-readable media in accordance with claim 17, wherein for at least one of the postconditions, there is a parameter and an expected result for the parameter.
